(19) United States
(12) Patent Application Publication
(10) Pub. No.: US 2010/0110395 A1
(43) Pub. Date: May 6, 2010

(54) IMAGE DISPLAY DEVICE AND LAMP UNIT

(75) Inventors: Kazunori KOTANI, Nara-city (JP); Hirofumi KAZUMORI, Kizugawa-city (JP); Shigeyuki HASHIZUME, Shijonawate-city (JP); Hisashi NAKAMURA, Kobe-city (JP); Takeshi HIGASHINO, Kyoto-city (JP)

Correspondence Address: NOVAK DRUCE + QUIGG LLP, 1300 EYE STREET NW, SUITE 1000 WEST TOWER, WASHINGTON, DC, 20005, US

(73) Assignee: SANYO ELECTRIC CO., LTD., Osaka (JP)

(21) Appl. No.: 12/612,669

(22) Filed: Nov. 4, 2009

(30) Foreign Application Priority Data
Nov. 5, 2008 (JP) 2008-284684

(51) Int. Cl. G03B 21/20

(52) U.S. Cl. 353/119

(57) ABSTRACT

A lamp unit is provided with a storage part that holds lamp management information in a writable and readable manner. A communication control part on a projector main unit side reads the lamp management information from the lamp unit and stores the same in a storage part of the main unit. The lamp management information is updated depending on the status of use of the lamp unit. The updated lamp management information is written back into the storage part of the lamp unit.

This application claims priority under 35 U.S.C. Section 119 of Japanese Patent Application No. 2008-284684 filed Nov. 5, 2008, entitled “IMAGE DISPLAY DEVICE AND LAMP UNIT”. The disclosures of the above application is incorporated herein by reference.

### BACKGROUND OF THE INVENTION

1. Field of the Invention

The present invention relates to an image display device and a lamp unit attached to the image display device, and in particular is suitable for use in the case where the lamp unit is replaceable.

2. Disclosure of the Related Art

Currently, there are commercialized and widespread projection display devices that project a magnified image onto a screen (hereinafter referred to as “projectors”). In such projectors, a lamp is generally used as a light source and light from the lamp is modulated by an imager and is projected onto a screen.

In this arrangement, when the lamp has run out in the middle of projecting operation, image display is interrupted. To handle such a situation, the lamp is generally made replaceable in the projector.

If lamp replacement can be performed easily, it can be conceived that lamps are replaced as appropriate depending on the scenes of using the projector. For example, when making a presentation with the projector, an old lamp is used for practice and a new high-intensity lamp is used for the real presentation.

For frequent lamp replacement, each lamp needs to be managed for lifetime, compatibility with projectors, and others. In general, lamps deteriorate depending on the status of use. Therefore, if lamps are to be often replaced, it is necessary to control the lamps on the basis of usage history.

### SUMMARY OF THE INVENTION

An object of the present invention is to allow proper control of lamps on the basis of usage history.

A first aspect of the present invention relates to an image display device. The image display device in the first aspect includes a lamp holder that holds a lamp; a lamp-side circuit part that is disposed on the lamp holder side; a holder housing that houses the lamp holder detachably; a main unit-side circuit part that is disposed on a main unit side; and a connector that connects electrically the lamp-side circuit part and the main unit-side circuit part. The lamp-side circuit part has a storage part that stores lamp management information for managing the lamp in a writable and readable manner. The main unit-side circuit part has an information update part that reads the lamp management information from the storage part and updates the lamp management information depending on the status of use of the lamp; and an update storage part that writes the updated lamp management information back into the storage part.

According to the image display device in this embodiment, the storage part storing lamp management information is disposed on the lamp side, and the lamp management information held in the storage part is updated depending on the status of use of the lamp. This allows the lamp to hold the lamp management information reflected by the usage history, whereby the lamp can be properly managed on the basis of the information.

In the image display device in the first aspect, the lamp management information may contain cumulative time information on cumulative operating time of the lamp. In this case, the information update part updates the cumulative time information depending on the status of use of the lamp. The update storage part writes the updated cumulative time information back into the storage part. This allows the lamp to hold the cumulative operating time of the lamp as a usage history record, whereby it is possible to determine a lifetime of the lamp and the like on the basis of the information.

In the first aspect, the “cumulative operating time” refers to a total amount of operating time of a lamp unit after manufacture, which includes the total amount of illuminating time from the first use after manufacture until the present time.

A second aspect of the present invention relates to a lamp unit. The lamp unit in the second aspect includes a lamp holder that holds a lamp; a lamp circuit part that is disposed on the lamp holder side; and a connector that connects the lamp circuit part electrically to a circuit part on a main unit side. Here, the lamp circuit part has a storage part that stores lamp management information for managing the lamp in a writable and readable manner.

### BRIEF DESCRIPTION OF THE DRAWINGS

FIG. 1 is a perspective overview of a projector in an embodiment of the present invention;

FIG. 2 is a plane view showing a configuration of an optical engine in the embodiment;

FIGS. 3A and 3B are perspective views of a configuration of a mirror unit in the embodiment;

FIG. 4 is an exploded perspective view of a configuration of a lamp unit in the embodiment;

FIGS. 5A and 5B are enlarged perspective views of a part of the lamp unit in the embodiment;

FIGS. 6A and 6B are perspective views of a configuration of a circuit board of the lamp unit in the embodiment;

FIG. 7 is a perspective view for describing a method for attachment of the lamp unit in the embodiment;

FIGS. 8A, 8B, and 8C are perspective views of the attached lamp unit in the embodiment; and

FIG. 9 is a partial cross section view of the attached lamp unit in the embodiment.

FIG. 10 is a diagram showing a circuit configuration of a projector in the embodiment;

FIG. 11A is a diagram showing a system configuration of a controller and a circuit part on the lamp unit side in the embodiment; FIGS. 11B and 11C are diagrams showing data for use in the configuration shown in FIG. 11A;

FIG. 12 is a flowchart of an updating process of cumulative operating time in the embodiment; and

FIG. 13 is a flowchart of a process performed for the case where lamp information could not be read, in the embodiment.

However, the drawings are only for the purpose of illustration and do not limit the scope of the present invention.

### DESCRIPTION OF PREFERRED EMBODIMENTS

Hereafter, a configuration of a projector in an embodiment of the present invention will be described with reference to the drawings. The projector in this embodiment has two lamp units as light sources of the illuminating device.

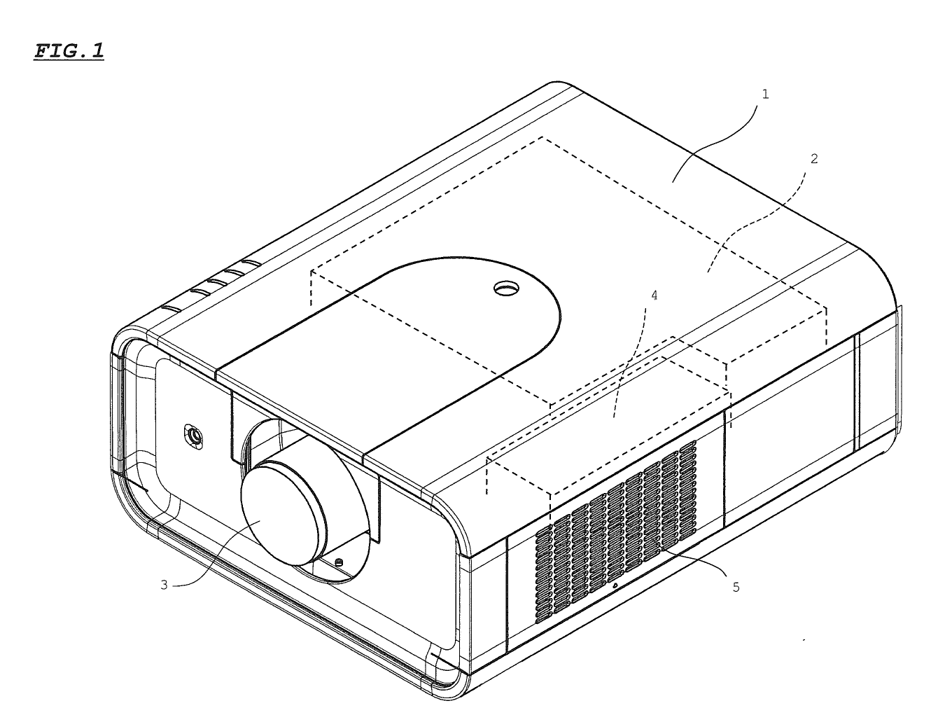

FIG. 1 is a perspective overview of the configuration of the projector. The projector includes a cabinet 1. The cabinet 1 is shaped like an approximately rectangular parallelepiped that is vertically thin and horizontally long, and has an intake port 5 on a side surface to take external air into the cabinet 1. The cabinet 1 also has on a rear side an openable and closable lamp cover (not shown). The user can open the lamp cover as necessary to replace the lamp units.

The cabinet 1 includes an optical engine 2, a projection lens 3, and a cooler 4 therein. The optical engine 2 generates light modulated by an image signal (image light). The optical engine 2 has the projection lens 3 attached. A front part of the projection lens 3 is exposed from a front surface of the cabinet 1. The image light generated by the optical engine 2 is projected by the projection lens 3 onto a surface of a screen in front of the projector. The cooler 4 takes in external air from the intake port 5, and supplies the external air as cooling winds to the optical engine 2.

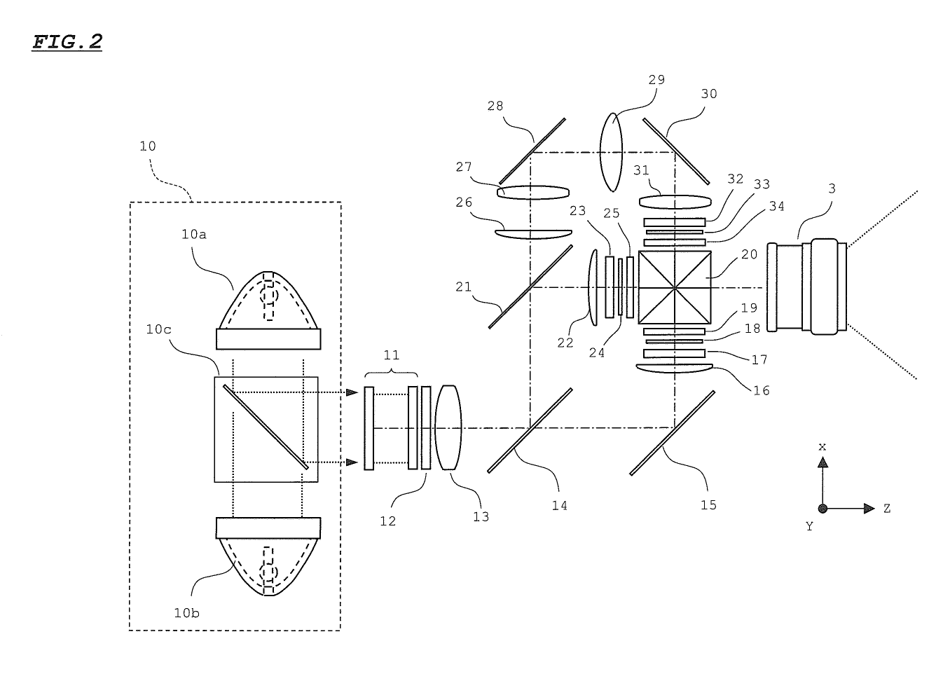

FIG. 2 is a diagram showing a configuration of the optical engine. In FIG. 2, reference numeral 10 denotes an illuminating device having two lamp units 10a and 10b and a mirror unit 10c. The lamp units 10a and 10b include lamps formed by extra high-pressure mercury lamps, metal halide lamps, xenon lamps, or the like. Light from the lamp units 10a and 10b is launched as approximately parallel light by the action of a reflector. A configuration of the lamp units 10a and 10b will be described later in detail.

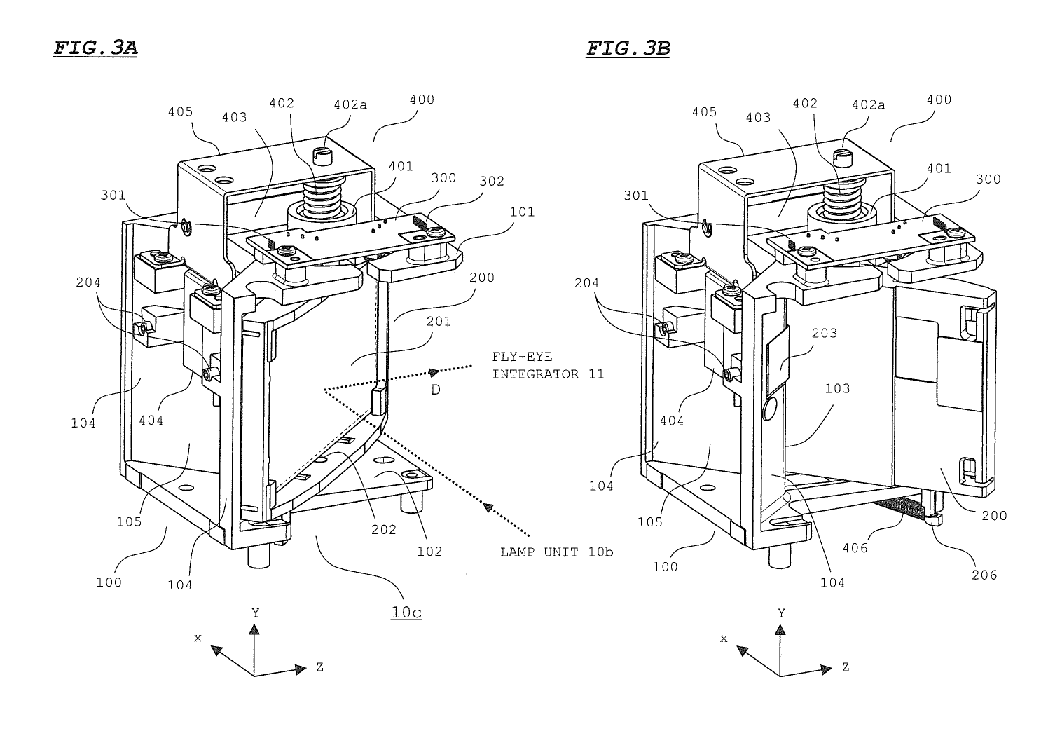

The mirror unit 10c has a mirror rotatable in parallel to an X-Z plane shown in FIG. 2. The mirror is rotated to guide light from the lamp unit 10a to a fly-eye integrator 11 when the lamp unit 10a is activated, and to guide light from the lamp unit 10b to the fly-eye integrator 11 when the lamp unit 10b is activated. A configuration of the mirror unit 10c will be described later with reference to FIGS. 3A, 3B, 4, 5A, and 5B.

Light from the illuminating device 10 is entered into a polarized beam splitter (PBS) array 12 and a condenser lens 13 via the fly-eye integrator 11. The fly-eye integrator 11 includes first and second fly-eye lenses formed by fly-eye lens groups. The fly-eye integrator 11 exerts an optical effect on the incident light from the illuminating device 10 so as to bring a uniform distribution of amounts of incident light on liquid crystal panels 18, 24, and 33.

The PBS array 12 includes an array of a plurality of PBS' s and half-wavelength plates, and unifies polarization directions of incident light from the fly-eye integrator 11. The condenser lens 13 exerts an effect of gathering the incident light from the PBS array 12. The light having passed through the condenser lens 13 is entered into a dichroic mirror 14.

Out of the incident light from the condenser lens 13, the dichroic mirror 14 lets only blue-waveband light (hereinafter referred to as “B light”) pass through and reflects red-waveband light (hereinafter referred to as “R light”) and green-waveband light (hereinafter referred to as “G light”). After having passed through the dichroic mirror 14, the B light is reflected by a mirror 15 and then is entered into a condenser lens 16.

The condenser lens 16 exerts an optical effect on the B light so that the B light is entered as approximately parallel light into a liquid crystal panel 18. After having passed through the condenser lens 16, the B light is entered into the liquid crystal panel 18 via an incident-side polarizer 17. The crystal panel 18 is driven in accordance with an image signal for blue color to modulate the B light depending on the driven state. After having modulated by the liquid crystal panel 18, the B light is entered into a dichroic prism 20 via an output-side polarizer 19.

Out of the light reflected by the dichroic mirror 14, the G light is reflected by a dichroic mirror 21 and then is entered into a condenser lens 22. The condenser lens 22 exerts an optical effect on the G light so that the G light is entered as approximately parallel light into a liquid crystal panel 24. After having passed through the condenser lens 22, the G light is entered into the liquid crystal panel 24 via an incident-side polarizer 23. The liquid crystal panel 24 is driven in accordance with an image signal for green color to modulate the G light depending on the driven state. After having modulated by the liquid crystal panel 24, the G light is entered into the dichroic prism 20 via an output-side polarizer 25.

After having passed through the dichroic mirror 21, the R light is entered into a condenser lens 26. The condenser lens 26 exerts an optical effect on the R light so that the R light is entered as approximately parallel light into a liquid crystal panel 33. After having passed through the condenser lens 26, the R light travels along a light path that is formed by relay lenses 27, 29, and 31 for adjustment of light path length and two mirrors 28 and 30, and then the R light is entered into a liquid crystal panel 33 via an incident-side polarizer 32. The liquid crystal panel 33 is driven in accordance with an image signal for red color to modulate the R light depending on the driven state. After having modulated by the liquid crystal panel 33, the R light is entered into the dichroic prism 20 via an output-side polarizer 34.

The dichroic prism 20 combines the B, G, and R light respectively modulated by the liquid crystal panels 18, 24, and 33, and enters the same into the projection lens 3. The projection lens 3 includes a lens group that produces an image of projected light on a projection plane, and an actuator that displaces part of the lens group in a direction of a light axis to thereby adjust zoom and focus states of a projected image. The light combined by the dichroic prism 20 is magnified and projected onto a screen by the projection lens 3.

Next, a configuration of the mirror unit 10c will be described with reference to FIGS. 3A and 3B.

FIGS. 3A and 3B are perspective views of the configuration of the mirror unit 10c.

In FIGS. 3A and 3B, a base 100 includes an upper plate 101, a lower plate 102, a rear plate 103, and two walls 104. The upper plate 101, lower plate 102, rear plate 103, and two walls 104 are integrally formed by aluminum die casting. In addition, a hollow 105 is provided between the two walls 104 so as to continue to the upper plate 101. The lower plate 102 and the upper plate 101 are parallel to each other. A mirror holder 200 is rotatably provided between the lower plate 102 and the upper plate 101.

The two walls 104 and the rear plate 103 have on inner sides a concave contoured to be slightly larger than an adjustment plate 203. The adjustment plate 203 is fitted and screwed in the concave. The adjustment plate 203 is screwed at a central part on the rear plate 103 and is pressed at parts corresponding to the two walls 104 against the two walls 104 so as to be capable of being elastically displaced. The adjustment plate 203 is formed of a flexible, thin metal film. In addition, the two walls 104 have adjustment screws 204 screwed on outer surfaces, and ends of the adjustment screws 204 are in contact with the adjustment plate 203.

The two walls 104 are formed such that inner surfaces thereof are inclined at an angle of approximately 45 degrees with respect to the respective travel directions of light from the lamp units 10a and 10b when the mirror unit 10c is disposed in the optical engine shown in FIG. 2.

The mirror holder 200 is provided with a mirror 201. The mirror holder 200 also has projecting shafts 202 in coaxial positions on upper and lower surfaces. The shaft 202 on the lower surface of the mirror holder 200 is fitted into a shaft hole in the lower plate 102. The shaft 202 on the upper surface of the mirror holder 200 is attached to a torque limiter 402 via a shaft bearing.

The upper plate 101 has on the upper surface a substrate 300 attached via bosses. The substrate 300 has two detection switches 301 and 302 on a lower surface. The detection switches 301 and 302 are pressed and turned on by projections (not shown) on the upper surface of the mirror holder 200 when the mirror holder 200 is brought into a rotation termination position.

A drive part 400 includes a gear 401 with a torque limiter 402, a gear 403, a motor 404, a gear (not shown) attached to a drive shaft of the motor 404, a cover 405, and a coil spring 406 disposed on the lower plate 102 side. The torque limiter 402 causes the gear 401 to run idle when a specific or higher level of torque is applied. The gear 403 is rotatably attached to the cover 405. The cover 405 has a shaft hole that engages with a shaft 402a of the torque limiter 402. The cover 405 is screwed into the bosses formed on outer surfaces of the walls 104. The motor 404 is attached in the hollow 105 between the two walls 104.

A driving force from the motor 404 is transferred to the torque limiter 402 via the gear attached to the drive shaft of the motor 404 and the gears 403 and 401. The driving force is further transferred to the shaft 202 on the upper surface of the mirror holder 200, which is attached to the torque limiter 402. This arrangement allows the mirror 201 to rotate with the mirror holder 200.

The lower plate 102 has a coil spring 406 on a bottom surface. The coil spring 406 is mounted on the mirror unit 10c such that both ends thereof are locked between a hook formed on the lower surface of the mirror holder 200 and a hook formed on the bottom surface of the lower plate 102. The coil spring 406 biases the mirror holder 200 in a direction that presses the mirror holder 200 against the front wall 104 in a state shown in FIG. 3A, and biases the mirror holder 200 in a direction that presses the mirror holder 200 against the back wall 104 in a state shown in FIG. 3B.

The rotation termination position of the mirror holder 200 can be adjusted by an amount of lifting of the adjustment plate 203 using the adjustment screws 204. When the mirror unit 10c is incorporated into the optical engine shown in FIG. 2, the adjustment screws 204 are used to adjust the amount of lifting of the adjustment plate 203 so that light from both the lamp units 10a and 10b travels properly toward the fly-eye integrator 11.

As shown in FIG. 3A, light from the lamp unit 10b is reflected and guided by the mirror 201 to the fly-eye integrator 11. To switch to the other lamp unit, the motor 404 is driven to rotate the mirror unit 200 counterclockwise. This rotation is continued until a specific period of time has elapsed after the detection switch 302 is turned on.

In the meantime, the mirror unit 200 is pressed against the adjustment plate 203 to position the mirror 201 at a position shown in FIG. 3B. During the pressing, the gear 401 runs idle by the action of the torque limiter 402. Accordingly, the mirror unit 200 is situated in a position shown in FIG. 3B, and light from the lamp unit 10a is reflected and guided by the mirror 201 to the fly-eye integrator 11. If the mirror unit 10c is switched from the state of FIG. 3B to the state of FIG. 3A, the same operation as described above is performed except that the direction of driving the motor 404 is reversed.

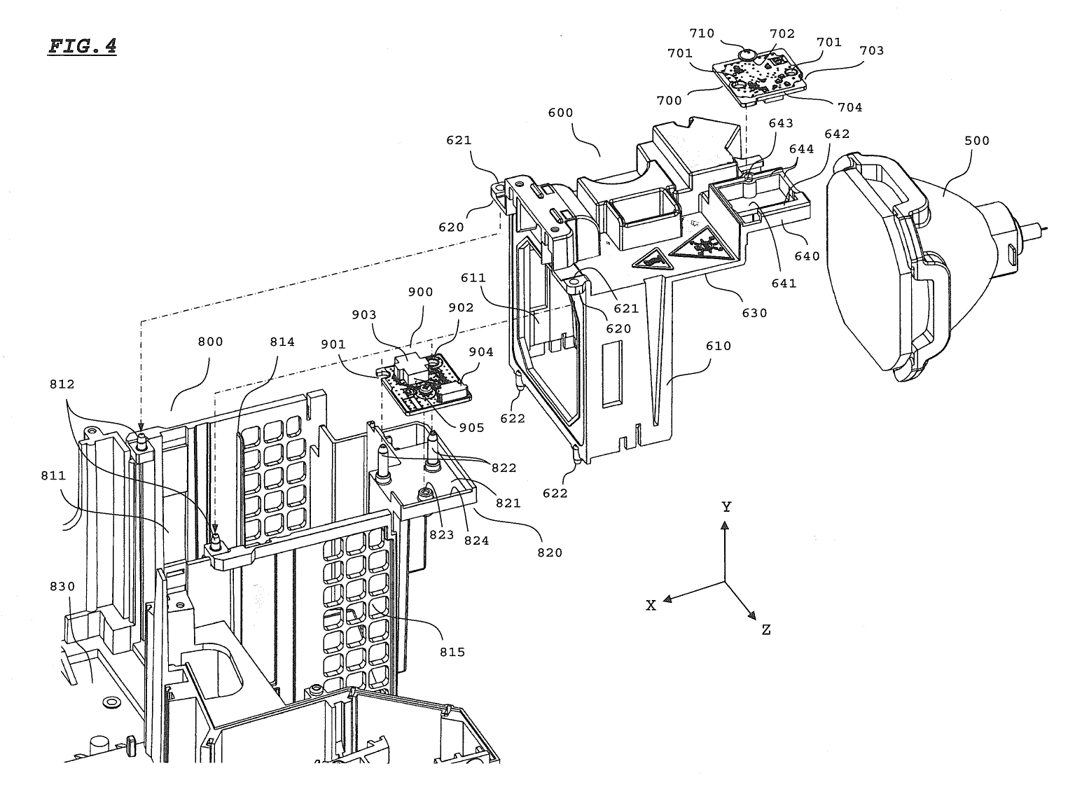

Next, a configuration of a lamp unit and a method of mounting the lamp unit will be described below with reference to FIGS. 4 to 8A, 8B, and 8C. The following description is given taking one lamp unit as an example, but the described configuration and mounting method are applicable to both of the two lamp units 10a and 10b shown in FIG. 2.

FIG. 4 is a diagram showing the configuration of a lamp unit and a mounting portion thereof. The lamp unit includes a lamp 500, a lamp holder 600 holding the lamp 500, and a circuit board 700. Meanwhile, the main unit chassis side has a holder housing 800 housing the lamp holder 600 and a circuit board 900. The mirror unit 200 is attached to a mirror unit attachment part 830 shown in FIG. 4.

The lamp holder 600 includes a box 610 to which the lamp 500 is attached. The box 610 has on a front surface an opening 611 for guiding light from the lamp 500 forward. The box 610 also has forward projecting flanges 620 with holes 621 on an upper front surface. The box 610 further has two downward projecting pins 622 on the upper front surface. In addition, the box 610 has on an upper rear surface a backward projecting L-shaped flange 630 with a board holding part 640 extending therefrom.

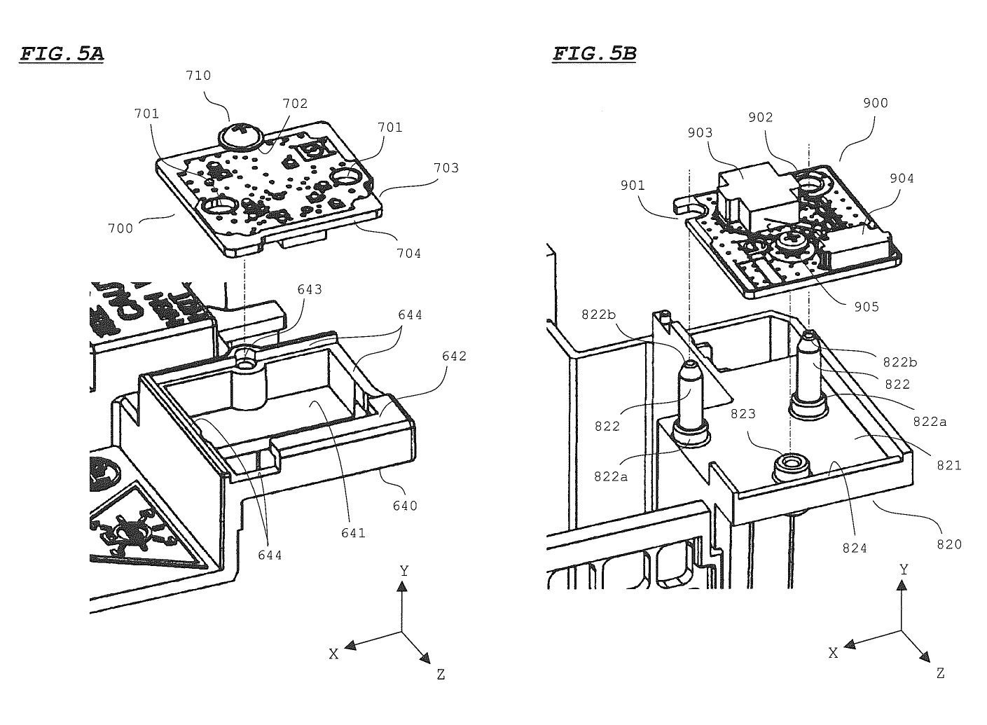

FIG. 5A is an enlarged view of the board holding part 640. The board holding part 640 has a vertically penetrating opening 641. The board holding part 640 also has on an upper surface an L-shaped locking part 642 locking the circuit board 700 in X- and Y-axis directions. The board holding part 640 also has a screw hole 643 into which a screw 710 is screwed. The board holding part 640 further has on the upper surface a placement part 644 on which an outer edge of the circuit board 700 is placed.

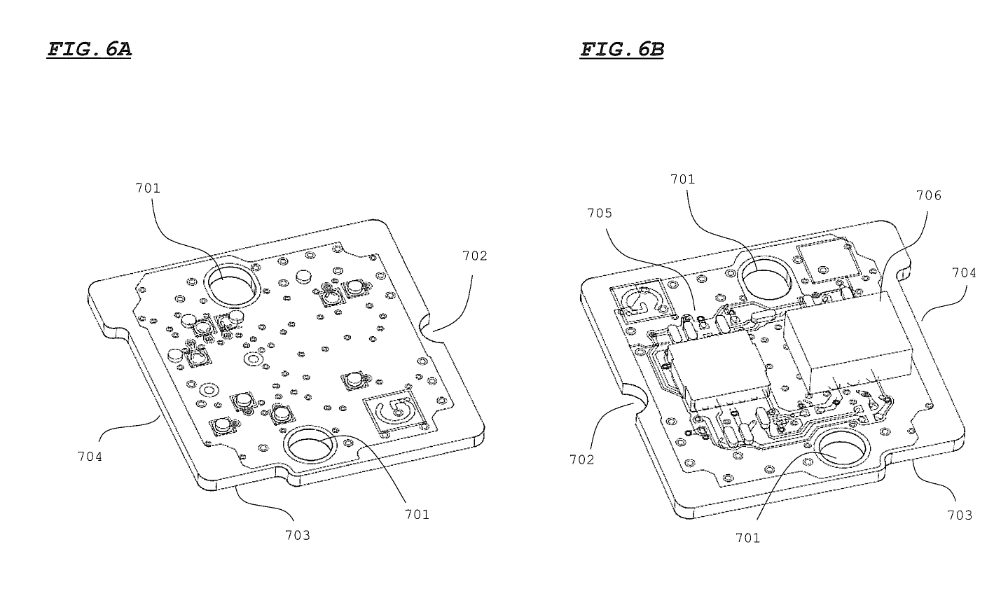

FIGS. 6A and 6B are diagrams showing a configuration of the circuit board 700. FIG. 6A is a top view and FIG. 6B is a bottom view. The circuit board 700 includes two holes 701 and a notch 702 in a position corresponding to a side screw 710. The circuit board 700 also has notches 703 and 704 in positions corresponding to the locking part 642 of the board holding part 640. The circuit board 700 has on the bottom surface a circuit part 705 including an IC and a connector 706 electrically connected to the circuit part 705.

Referring to FIG. 5A, the circuit board 700 is contoured so as to be displaceable only by a predetermined stroke in the X- and Z-axis directions when the outer edge thereof is placed on the placement part 644 while the notches 703 and 704 are fitted into the locking part 642. In addition, the placement part 644 is sufficiently widened so that the circuit board 700 does not fall into the opening 641 even if the circuit board 700 is displaced as described above.

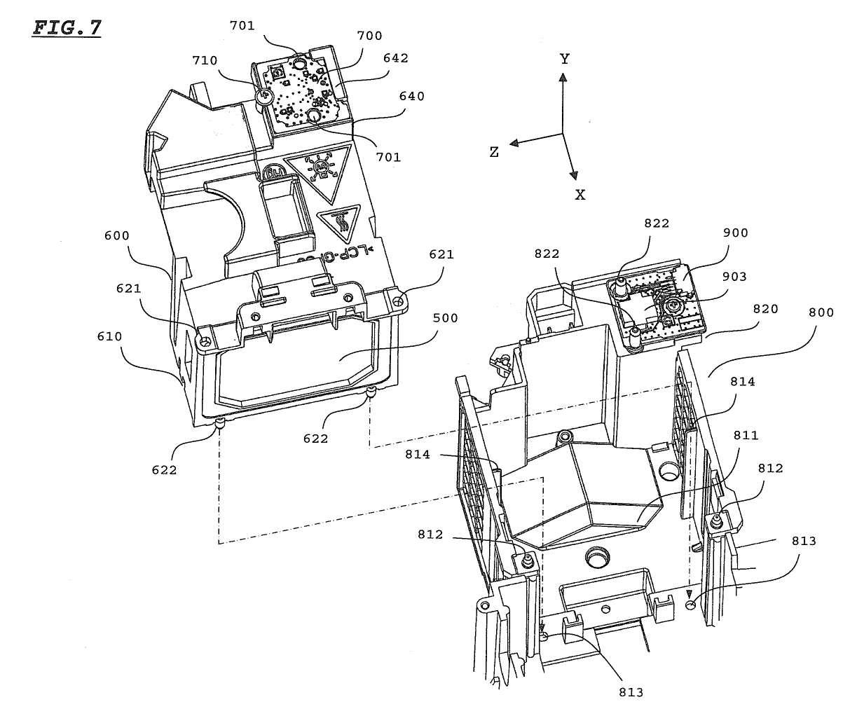

Returning to FIG. 4, the holder housing 800 includes a box attachment part 811 that is open on front and upper sides. The box 610 of the lamp holder 600 is attached to the box attachment part 811. The box attachment part 811 has, on an upper front side, pins 812 respectively engaging with the two holes 621 of the lamp holder 600. The box attachment part 811 also has, on a front bottom side, holes 813 (not shown in FIG. 4. Refer to FIG. 7) respectively engaging with the two pins 622 of the lamp holder 600. The box attachment part 811 further has a pair of vertically extending guides 814 that lock the rear surface of the box 610 and guide the lamp holder 600 when the lamp holder 600 is attached. The box attachment part 811 has on two walls a ventilation opening 815 that allows winds to pass through the box attachment part 811.

The holder housing 800 has a board holding part 820 that is opposed to the board holding part 640 of the lamp holder 600 when the lamp holder 600 is attached.

FIG. 5B is an enlarged view of the board holding part 820. The board holding part 820 has a concave 821, two pins 822 projecting from the concave 821, and a screw hole 823. The board holding part 820 also has a notch 824 near the screw hole 823 on a wall surrounding the concave 821.

The circuit board 900 has a notch 901 and a hole 902, which engage with the two pins 822 on the board holding part 820. The circuit board 900 also has on an upper surface a connector 903 that connects with the connector 706 on the circuit board 700 disposed in the lamp holder 600, and a connector 904 that connects the connector 903 electrically to the main board. The circuit board 900 can be attached to the board holding part 820 by screwing the screw 905 into the screw hole 823.

Returning to FIG. 4, for mounting the lamp unit, first the lamp 500 is attached to the box 610 of the lamp holder 600. Then, the circuit board 700 is attached to the board holding part 640 of the lamp holder 600. Referring to FIG. 5A, the circuit board 700 can be attached by placing the circuit board 700 on the placement part 644 while fitting the notches 703 and 704 into the L-shaped locking part 642, and then screwing the screw 710 into the screw hole 643. At the time, the screw 710 is screwed into the screw hole 643 in such a manner that a slight clearance is left between the screw head and the upper surface of the circuit board 700. Accordingly, the circuit board 700 can be attached to the board holding part 640 so as to be displaceable only by a predetermined stroke in the X- and Z-axis directions.

Returning to FIG. 4, the circuit board 900 is attached to the board holding part 820 in the main unit chassis. Referring to FIG. 5B, for attachment of the circuit board 900, the circuit board 900 is placed on the notch 824 and on seats 822a at a base of the two pins 822 while the notch 901 and the hole 902 are fitted to the two pins 822, respectively. An upper surface of the seat 822a and an upper surface of the notch 824 are at the same height. Subsequently, the screw 905 is screwed into the screw hole 823.

Here, the notch 901 and the hole 902 are engaged with the pins 822 with almost no play. Accordingly, when being placed on the notch 824 and the seats 822a at the base of the pins 822 as stated above, the circuit board 900 is positioned in the X- and Z-axis directions with respect to the board holding part 820. In addition, the screw 905 is screwed into the screw hole 823 until the screw 905 is pressurized and brought into contact with the upper surface of the circuit board 900. This allows the circuit board 900 to be incapable of being displaced also in the Y-axis direction and thus be positioned in the Y-axis direction.

FIG. 7 is a diagram of the lamp unit in which the two circuit boards 700 and 900 are attached to the board holding parts 640 and 820, respectively. Subsequently, the lamp holder 600 is mounted to the holder housing 800 by pushing the box 610 into the box attachment part 811 while bringing the rear surface of the box 610 into contact with the guides 814.

A distance from a front inner side of the box attachment part 811 to the guides 814 is made slightly larger than a length of the box 610 in the X-axis direction. Accordingly, the lamp holder 600 can be housed in the holder housing 800 in a predetermined position by pushing the box 610 into the box attachment part 811 while bringing the rear surface of the box 610 into contact with the guides 814.

When the lamp holder 600 is pushed into the box attachment part 811 as stated above, ends of the two pins 812 on the holder housing 800 side are inserted into the two holes 621 of the lamp holder 600 side, and ends of the two pins 622 on the lamp holder 600 side are inserted into the two holes 813 of the holder housing 800, before the lamp holder 600 reaches the predetermined position in the holder housing 800. At the same time, ends of the two pins 822 extending from the board holding part 820 are inserted into the two holes 701 of the circuit board 700.

Here, the pins 812 and 622 each have a tapered end, and therefore, when the lamp holder 600 is further pushed into the box attachment part 811, the lamp holder 600 is guided by the inclined ends of the pins 812 and 622 and then is placed into the predetermined position. Accordingly, the light axis of the lamp 500 attached to the lamp holder 600 is properly set with respect to a subsequent optical system.

In addition, the pins 822 have inclines 822b at tapered ends (refer to FIG. 5B). Therefore, when the lamp holder 600 is further pushed into the box attachment part 811 with the pins 822 inserted into the holes 701, the circuit board 700 is guided and displaced in the X- and Z-axis directions by the inclines 822b at the pin 822 ends. Accordingly, the connector 706 on the circuit board 700 is properly opposed to the connector 903 on the circuit board 900, and then the lamp holder 600 is further pushed to connect the connectors 706 and 903.

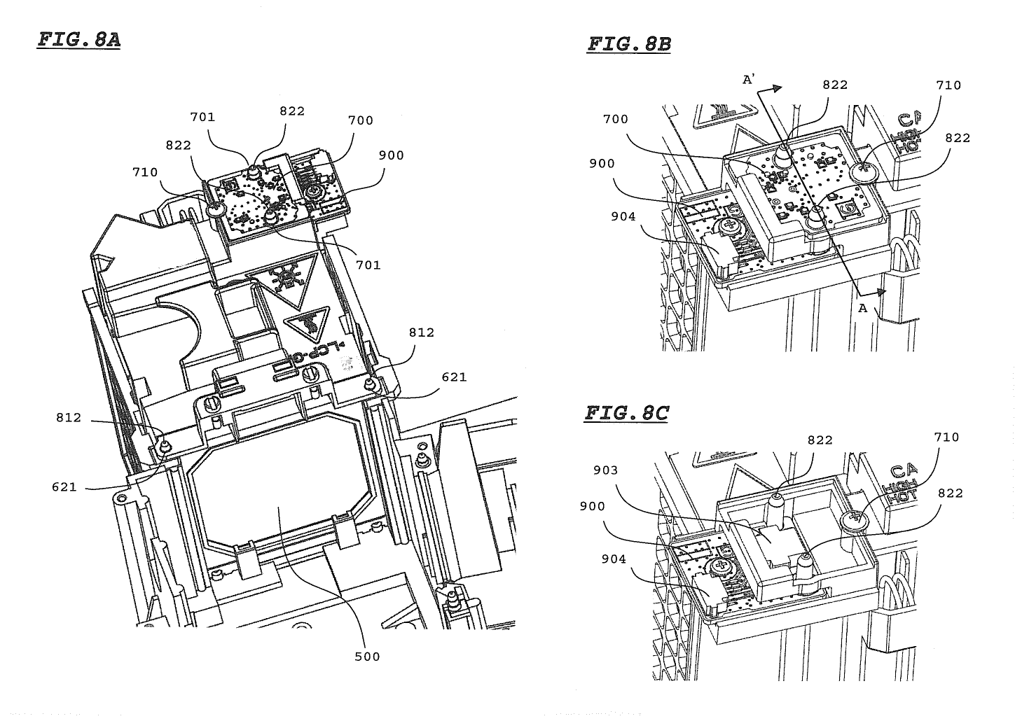

FIG. 8A is a diagram of the lamp unit in which the lamp holder 600 is pushed completely into the box attachment part 811. FIG. 8B is a perspective view of the vicinities of the board holding 640 and 820. FIG. 8C is a perspective view similar to that in FIG. 8B except that the board 700 removed. As shown in FIGS. 8A to 8C, when the lamp holder 600 is pushed completely into the box attachment part 811, the lamp 500 is properly positioned, and the connector 706 on the circuit board 700 and the connector 903 on the circuit board 900 are connected to each other.

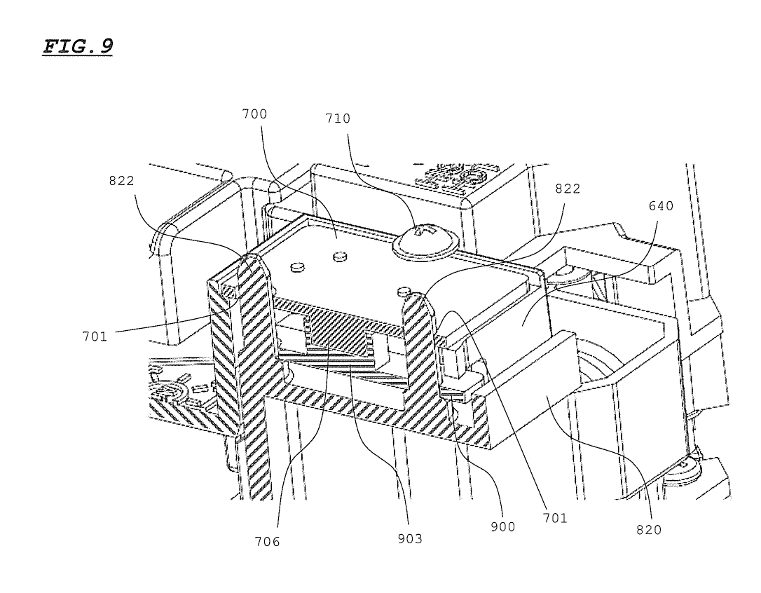

FIG. 9 is a cross section view of the diagram in FIG. 8B along a line A-A'. Length of the pins 822 is designed such that portions of the pins 822 further at the base than the ends thereof are fitted into the holes 701 of the circuit board 700, before the connector 903 on the circuit board 900 are connected to the connector 706 on the circuit board 700. Accordingly, when starting to connect with each other, the connectors 706 and 903 are completely positioned, thereby allowing smooth connection between the connectors 706 and 903.

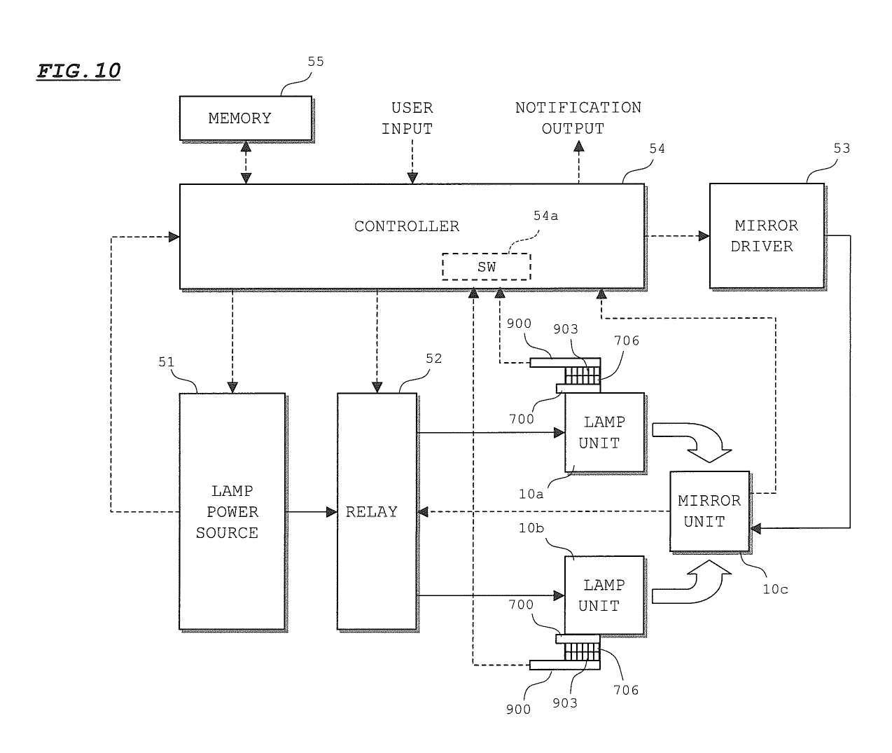

FIG. 10 illustrates a circuit configuration of a projector in this embodiment. FIG. 10 shows only a configuration related to the lamp units 10a and 10b and the mirror unit 10c, and other configurations are omitted.

A lamp power source 51 supplies power for driving a lamp to a relay circuit 52 in accordance with a control signal from a controller 54. The lamp power source 51 also monitors a voltage applied to the lamp 500 to thereby determine whether the lamp is on, and provides a result of the determination to the controller 54. Specifically, the lamp power source 51 provides the controller 54 with a determination that the lamp is on when the applied voltage is below a predetermined threshold, and provides the controller 54 with a determination that the lamp is off when the applied voltage is above the predetermined threshold.

The relay circuit 52 supplies the power from the lamp power source 51 to either one of the lamp units 10a and 10b which is designated by the controller 54. The relay circuit 52 receives signals from the detection switches 301 and 302 disposed on the mirror unit 10c. When the mirror 201 in the mirror unit 10c is directed toward the lamp unit 10a, the detection switch 301 is turned on and an ON signal from the detection switch 301 is input to the relay circuit 52. On the other hand, when the mirror 201 is directed toward the lamp unit 10b, the detection switch 302 is turned on and an ON signal from the detection switch 302 is input to the relay circuit 52.

The relay circuit 52 is configured so as not to supply the power from the lamp power source 51 to the lamp unit 10a if the detection switch 301 has not input an ON signal even though the controller 54 has input a control signal for power supply to the lamp unit 10a; and so as not to supply the power from the lamp power source 51 to the lamp unit 10b if the detection switch 302 has not input an ON signal even though the controller 54 has input a control signal for power supply to the lamp unit 10b.

A mirror driver 53 drives the mirror unit 10c in accordance with a control signal from the controller 54. At driving of the mirror unit 10c, the controller 54 monitors signals from the detection switches 301 and 302 disposed in the mirror unit 10c. Then, after the detection switch located in a driving direction has input an ON signal, the controller 54 provides a control signal to the mirror driver 53 to further drive the mirror 201 in the driving direction for a specific period of time. Accordingly, the mirror 201 can be reliably situated in a desired switch position.

When such control has been exercised, the motor 404 is continuously driven even after the rear surface of the mirror holder 200 has contacted the adjustment plate 203. In this case, however, the torque limiter 402 absorbs a driving force of the motor 404 as stated above, and therefore there arises no problem such as damage to the motor 404 under an overload or an angular shift of the mirror 201 due to a skew in the mirror holder 200.

The controller 54 includes a CPU (not shown) and a switch 54a, and controls the components according to pre-loaded control programs. The switch 54a connects either one of the circuit parts 705 disposed on the lamp units 10a and 10b to a data bus in the controller 54. The controller 54 switches the switch 54a so as to establish a communication path with either one of the circuit parts 705 disposed on the lamp units 10a and 10b. Then, the controller 54 acquires lamp management information from the circuit part 705 via the communication path, and stores the acquired management information in a memory 55.

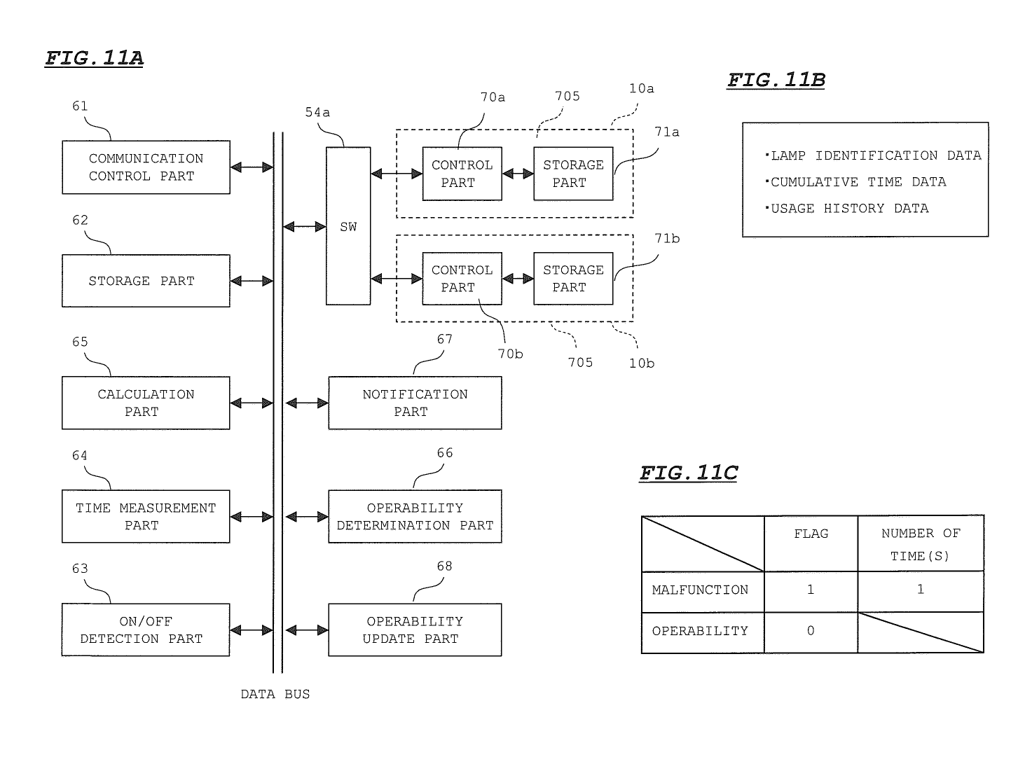

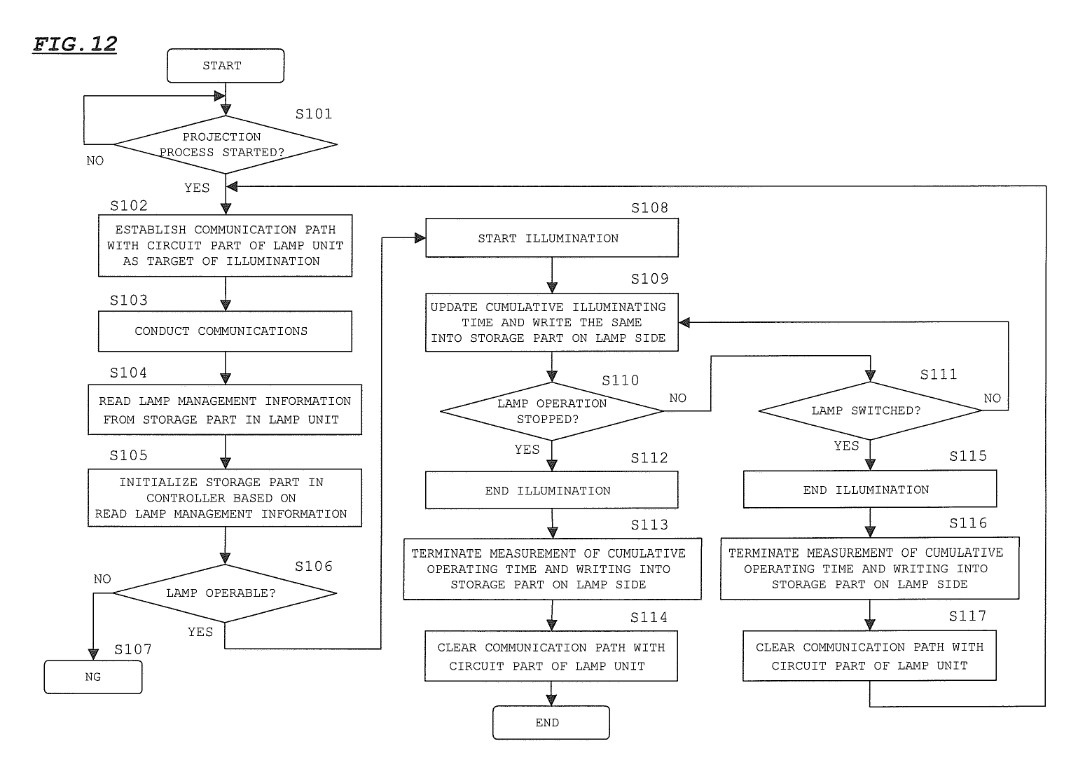

A configuration and a control operation relating to communications between the controller 54 and the circuit parts 705 disposed on the lamp units 10a and 10b will be described later in detail with reference to FIGS. 11A to 11C, and 12.

In the configuration of FIG. 10, when the lamp has burnt out during driving of either one of the lamps, the lamp power source 51 inputs a signal indicative of this event to the controller 54. In response to this, the controller 54 causes the lamp power source 51 to stop power supply, and then provides a control signal to the mirror driver 53 so as to rotate the mirror 201 into a position where light from the other lamp is reflected. Accordingly, the mirror 201 is rotated.

Afterward, when the mirror is rotated into the proper position, either one of the detection switches 301 and 302 provides an ON signal to the controller 54. After a lapse of the specific period of time since reception of the ON signal, the controller 54 outputs a control signal to the lamp power source 51 so as to start power supply. At the same time, the controller 54 outputs a control signal to the relay circuit 52 to supply power to the other lamp. Accordingly, the other lamp is turned on to resume projection of an image.

Next, a configuration relating to communications between the controller 54 and the circuit parts 705 disposed on the lamp units 10a and 10b will be described below with reference to FIGS. 11A to 11C.

FIG. 11A is a block diagram of a system including the controller 54 and the circuit parts 705; FIG. 11B is a diagram showing contents of lamp management information stored in the storage parts 71a and 71b; and FIG. 11C is a diagram showing a configuration of usage history data in the lamp management information. FIG. 11A omits the connectors 706 and 903 intervening between the switch 54a and the circuit parts 705, and the intermediate circuit board 900.

As shown in FIG. 11A, the circuit parts 705 of the lamp units 10a and 10b include control parts 70a and 70b and the storage parts 71a and 71b. The control parts 70a and 70b control writing/reading of data into/from the storage parts 71a and 71b. The storage parts 71a and 71b store data shown in FIG. 11B as lamp management information.

Here, lamp identification information refers to data for identifying the lamps 500 attached to the lamp units 10a and 10b, and contains data on manufacturer's name, model number, and the like of the lamps 500, for example. Cumulative time data refers to data indicative of cumulative operating time of the lamp 500. The “cumulative operating time” refers to a total amount of operating time of the lamp 500 after manufacture, which includes the total amount of illuminating time from the first use after manufacture until the present time.

Usage history data contains a flag for malfunction and a flag for operability as shown in FIG. 11C. Here, the flag for malfunction is set at “1” if the lamp 500 has failed to illuminate even once in the past, and is set at “0” if the lamp 500 has never failed to illuminate in the past. The flag for operability is set at “1” if the lamp 500 has become inoperable because the lamp 500 failed to illuminate beyond a predetermined number of times in the past, and is set at “0” if the lamp 500 has never become inoperable.

Returning to FIG. 11A, the controller 54 includes a communication control part 61; a storage part 62; an on/off detection part 63; a time measurement part 64; a calculation part 65; an operability determination part 66; a notification part 67; and an operability update part 68.

The communication control part 61 switching-controls the switch 54a so as to establish a communication path with either one of the circuit parts 705 disposed on the lamp units 10a and 10b. Then, the communication control part 61 acquires the lamp management information from the storage part 71a or 71b in the circuit part 705 with which the communication path is established.

The storage part 62 stores the lamp management information acquired by the communication control part 61. The lamp management information stored in the storage part 62 is updated as necessary in processes performed by the calculation part 65 and the operability update part 68 upon the use of the lamp. The storage part 62 sets a storage region for the lamp management information in the memory 55.

The on/off detection part 63 determines on illumination start and illumination end of the lamp 500 as a target of illumination, on the basis of a result of the determination on lamp illumination provided by the lamp power source 51. Specifically, while the lamp 500 is being driven, the on/off detection part 63 detects that the lamp 500 has started illumination at the instant when the lamp power source 51 has provided a determination that the lamp 500 is on, and then the on/off detection part 63 detects that the lamp 500 has ended illumination at the instant when the lamp power source 51 has provided a determination that the lamp 500 is off. If the lamp 500 has ended illumination at switching of the lamp 500 or at termination of a projection process, the on/off detection part 63 detects that the lamp 500 has turned off at the instant when power supply to the lamp 500 has been stopped.

The time measurement part 64 starts time measurement upon reception of an illumination start signal from the on/off detection part 63, and passes a result of the measurement to the calculation part 65 at specific time intervals. In addition, the time measurement part 64 terminates time measurement upon reception of an illumination end signal from the on/off detection part 63, and passes a result of the measurement at the time of the termination to the calculation part 65.

The calculation part 65 updates the cumulative time data on the basis of the cumulative time data in the lamp management information stored in the storage part 62 and the result of measurement of elapsed time input from the time measurement part 64, and writes the updated cumulative time data back into the storage part 62.

The operability determination part 66 determines whether the lamp 500 as a target of illumination is compatible with the device (projector) with reference to the lamp identification data in the lamp management information stored in the storage part 62, and passes a result of the determination to the notification part 67. The operability determination part 66 holds in advance the listed lamp identification data for lamps compatible with the device (projector), and determines on compatibility of the lamp 500 depending on whether the lamp identification data stored in the storage part 62 is contained in the list.

The operability determination part 66 further determines whether the lamp 500 as a target of illumination is operable with reference to the usage history data in the lamp management information stored in the storage part 62, and passes a result of the determination to the notification part 67. Specifically, the operability determination part 66 refers to the operability flag in the usage history data (see FIG. 11C) and determines that the lamp 500 is inoperable if the operability flag is set at “1.”

If the result of the determination from the operability determination part 66 indicates incompatibility or inoperability, the notification part 67 performs a process to notify the effect to the user. For example, the notification may be displayed on the display part in the projector or may be output as a sound. If the lamp unit as a target of illumination is incompatible with the projector or is inoperable, the lamp unit is not turned on and the foregoing notification is given to the user.

The operability update part 68 updates the usage history data in the lamp management information stored in the storage part 62, depending on the status of use of the lamp 500. Specifically, the operability update part 68 refers to the usage history data stored in the storage part 62 if the lamp power source 51 has not provided a determination that the lamp 500 has been turned on for a specific period of time at start of illumination of the lamp 500, or if the power source 51 has provided a determination that the lamp 500 has been turned off during operation of the lamp 500. If the malfunction flag is set at “0,” the operability update part updates the malfunction flag to “1,” and sets the number of malfunction at 1. If the malfunction flag is already set at “1,” the operability update part increments the number of malfunction (s) by 1, and also sets the operability flag at “1” if the incremented number of malfunction(s) is above a threshold value.

Whenever the usage history data is updated as stated above, the communication control part 61 writes the update back into the storage part 71a or 71b in the corresponding lamp unit 10a or 10b. In addition, if any trouble has occurred in illumination of the lamp 500, illumination of the lamp 500 is stopped.

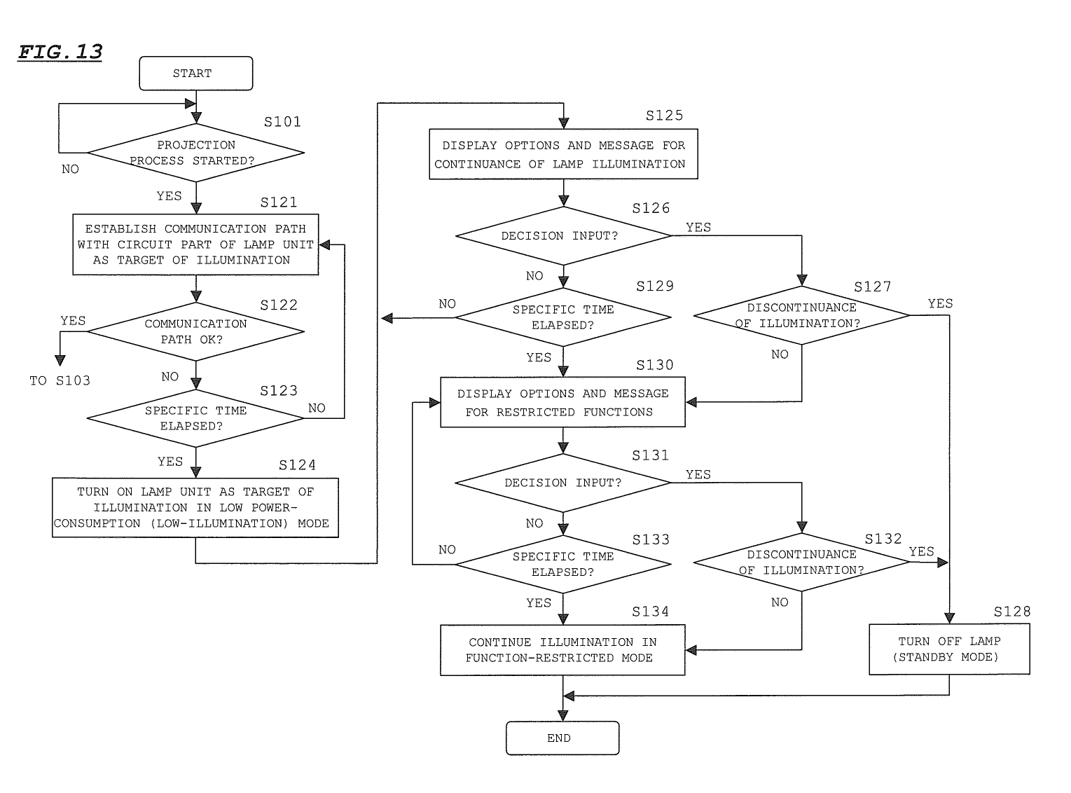

Next, an updating process of cumulative operating time will be described below with reference to FIG. 12. The steps of the flow shown in the diagram are to be carried out when it was possible to read the lamp management information from the lamp unit 10a or 10b. If it was not possible to read the lamp management information from the lamp unit 10a or 10b, the steps shown in FIG. 13 will be performed instead.

When a projecting process is started by input by a user (S101: YES), the communication control part 61 establishes a communication path with the circuit part 705 in the lamp unit 10a or 10b as a target of illumination (S102). Then, the communication control part 61 conducts communications with the circuit part 705 with which the communication path is established (S103), reads the lamp management information from the storage part 71a or 71b in the circuit part 705 (S104), and initializes the storage part 62 on the basis of the read lamp management information (S105).

Afterward, the operability determination part 66 refers to the lamp identification data and the usage history data (the operability flag) in the lamp management information stored in the storage part 62 to thereby determine whether the lamp unit 10a or 10b as a target of illumination is compatible with the device (projector) and is operable as stated above (S106). Here, if the lamp unit 10a or 10b is incompatible or inoperable (S106: NO), the operability determination part 66 notifies that the lamp unit is inoperable without turning on the lamp unit as stated above (S107). On the other hand, if the lamp unit 10a or 10b is not incompatible or inoperable (S106: YES), the lamp unit 10a or 10b starts to illuminate (S108).

When the lamp unit 10a or 10b as a target of illumination has started to illuminate in this manner, the time measurement part 64 starts to measure elapsed time. At the same time, the calculation part 65 updates cumulative operating time of the lamp unit 10a or 10b on the basis of the time measured by the time measurement part 64 and the cumulative time data stored in the storage part 62. Then, the calculation part 65 writes the updated cumulative operating time as necessary over the previous data in the storage part 62, and writes the update data back into the storage part 71a or 71b in the lamp unit 10a or 10b (S109). Such an update on the cumulative operating time is maintained until the lamp unit 10a or 10b stops illumination (S110: YES), or the lamp unit as a target of illumination is switched by the user or automatically (S111: YES).

When an illuminating operation of the lamp unit 10a or 10b has been stopped due to a malfunction of the lamp unit or by the user' s instruction (S110: YES), the lamp unit 10a or 10b ends illumination (S112). Here, an end of illumination due to a malfunction is based on the determination from the lamp power source 51 as stated above. In this case, the operability update part 68 updates the usage history data as stated above, and writes the updated usage history data back into the storage part 71a or 71b in the lamp unit 10a or 10b.

When the lamp unit 10a or 10b ends illumination at S112, the time measurement part 64 and the calculation part 65 terminate the measurement of elapsed time and the calculation of cumulative operating time, and then the cumulative operating time at the time is written back into the storage part 71a or 71b in the lamp unit 10a or 10b (S113). Afterward, the communication path is cleared (S114) and the process is terminated.

On the other hand, if it is determined at S111 that the lamp unit as a target of illumination has been switched (S111: YES), the lamp unit 10a or 10b ends illumination (S115). According to this, the time measurement part 64 and the calculation part 65 terminate the measurement of elapsed time and the calculation of cumulative operating time, and then the cumulative operating time at the time is written back into the storage part 71a or 71b in the lamp unit 10a or 10b (S116). Then, the communication path is cleared (S117), and the process returns to S102 to perform S102 and subsequent steps with respect to the switched lamp unit 10a or 10b.

Next, the process performed for the case where it was not possible to read the lamp management information from the lamp unit 10a or 10b, will be described with reference to FIG. 13.

As in the case of FIG. 12, when a projection process is started by input by the user (S101: YES), the communication control part 61 establishes a communication path with the circuit part 705 in the lamp unit 10a or 10b as a target of illumination (S121). Here, if the communication path can be established (S122: YES) within a specific period of time (S123), the process moves to S103 shown in FIG. 12 to conduct communications with the circuit part 705 with which the communication path is established. In this case, S104 and subsequent steps shown in FIG. 12 are carried out.

If the communication path cannot be established within the specific period of time (S122: N0, S123: YES), the controller 54 turns on the lamp unit 10a or 10b as a target of illumination in a low power-consumption and low-illumination mode (S124), and displays on a projection plane a message indicative of no proper lamp unit being attached and an image for the user to decide whether this lamp unit is to be continuously on (S125). In response to this, if the user inputs a decision via a remote control or a main unit key (S126: YES) and the decision is to discontinue the illumination (S127: YES), the controller 54 turns off the lamp unit, and brings the projector into a standby state (S128).

On the other hand, if the decision input by the user is to continue the illumination (S127: NO) or if the user has not input any decision within the specific period of time (S126: NO, s129: YES), the controller 54 displays on the projection plane a message indicating that some functions of the projector will be restricted if this lamp unit is continuously used and an image for the user to make a decision again on whether this lamp unit is to be continuously on (S130).

In this case, functional restrictions are imposed on a luminescence mode and an illumination switch mode for the lamp unit. For example, a message is provided to inform the user that the lamp unit will be brought into the low-illumination and low power-consumption mode and that the lamp unit will be incapable of being set in an automatic switch mode in which automatic switching takes place between the lamp units under predetermined control (for example, after each specific period of time), and therefore the lamp unit as a target of illumination is fixed to the currently operational lamp unit.

In response to this message, if the user input a decision via the remote control or the main unit key (S131: YES) and the decision is to discontinue the illumination (S132: YES), the controller 54 turns off the lamp unit, and brings the projector into the standby state (S128). On the other hand, if the decision input by the user is to continue the illumination (S132: NO) or if the user has not input any decision within the specific period of time (S131: NO, S133: YES), the controller 54 continuously illuminates the lamp unit under the functional restrictions stated above (S134).

According to this embodiment as described above, the storage parts 71a and 71b are disposed on the lamp unit 10a and 10b, and the lamp management information stored in the storage parts 71a and 71b is updated depending on the status of use of the lamp units 10a and 10b, whereby the lamps can hold the lamp management information reflected by the usage histories. Accordingly, when the lamp units 10a and 10b are used, it is possible to control properly illumination of the lamps on the basis of the lamp management information reflected by the usage histories.

In this embodiment, since cumulative operating time of the lamp is held as lamp management information, it is possible to determine a lifetime of the lamp on the basis of the information, for example. In addition, in accordance with the result of the determination, it is possible to notify the user of the coming of the end of the lifetime and the remaining amount of the lifetime, or to exercise control for automatic switching between the lamp units, for example.

In addition, since the information on operability of the lamp (usage history data) is held as lamp management information in this embodiment, it is possible to determine whether the lamp unit is operable at a time of use of the lamp unit as stated above. If the lamp unit is inoperable, it is possible to discontinue the illumination of the lamp unit. This avoids unnecessary illumination operations of the lamp.

Further in this embodiment, since the lamp identification information for identifying a lamp is held as lamp management information, it is possible to determine whether the lamp unit is compatible with the device (projector) at a time of use of the lamp unit as stated above. If the lamp unit is incompatible, it is possible to discontinue illumination of the lamp unit. This avoids illumination of the incompatible lamp and prevents damage to the lamp and the like.

Although an embodiment of the present invention has been described above, the present invention is not limited by the foregoing embodiment. In addition, the embodiment of the present invention can be modified in various manners.

For example, although the foregoing embodiment employs a projector on which two lamp units can be mounted, the number of lamp unit (s) may be one, or three or more. In addition, the lamp unit in the present invention is applicable to products other than projectors.

In addition, although the foregoing embodiment employs three kinds of data shown in FIG. 11B as lamp management information for managing a lamp unit, the lamp management information may contain information other than the foregoing information. For example, the lamp management information may contain information on the lamp's characteristics, such as intensity of illumination, color variability, and the like. Accordingly, it is possible to correct a projected image as appropriate on the projector side on the basis of the information, thereby improving the quality of the projected image.

In addition, the user may include by themselves the name, operation starting date, operational status, or the like of the lamp unit, as necessary in the lamp management information. Such information can be input via the operating part of the projection or can be written from a personal computer via a dedicated interface. This allows the user to check the lamp unit-specific information as necessary, resulting in enhanced convenience for the user.

Further in the foregoing embodiment, by every use of the lamp unit, the lamp management information is read from the lamp unit as a target of operation, and the storage part 62 is initialized on the basis of the read management information. Alternatively, if the storage part 62 has a sufficient capacity, lamp management information may be read and stored in the storage part 62 when the two lamp units 10a and 10b are attached.

Besides, the circuit board 900 is provided at the holder housing 800 as a relay to the main board in the foregoing embodiment. Alternatively, if the main board can be disposed in the vicinity of the holder housing 800 at a position corresponding to the board holding part 640 on the lamp holder 600 side, the main board may have a connector that connects with the connector 706 on the lamp holder 600. In addition to the arrangement in the foregoing embodiment, the two connectors in the present invention may be arranged in such a manner as to be attached to wires routed from the main board side and the lamp holder side and to be connected by hands to each other.

The embodiment of the present invention can be modified as appropriate in various manners within the scope of a technical idea shown in the claims.

What is claimed is:

1. An image display device, comprising:
a lamp holder for holding a lamp;
a lamp-side circuit part being disposed on the lamp holder;
a holder housing for housing the lamp holder detachably;
a main unit-side circuit part being disposed on a main unit side; and
a connector for connecting electrically the lamp-side circuit part and the main unit-side circuit part, wherein
the lamp-side circuit part has a storage part storing lamp management information for managing the lamp in a writable and readable manner, and
the main unit-side circuit part has:
an information update part for reading the lamp management information from the storage part and updating the lamp management information depending on the status of use of the lamp; and
an update storage part for writing the updated lamp management information back into the storage part.

2. The image display device according to claim 1, wherein
the lamp management information contains cumulative time information on cumulative operating time of the lamp,
the information update part updates the cumulative time information depending on the status of use of the lamp, and
the update storage part writes the updated cumulative time information back into the storage part.

3. The image display device according to claim 1, wherein
the lamp management information contains operability information on operability of the lamp,
the information update part updates the operability information depending on the status of use of the lamp, and
the update storage part writes the updated operability information back into the storage part.

4. The image display device according to claim 3, wherein
the main unit-side circuit part has an operability determination part that determines on operability of the lamp on the basis of the operability information.

5. The image display device according to claim 1, wherein
the lamp management information contains lamp identification information for identifying the lamp, and
the main unit-side circuit part has a lamp determination part for determining whether the lamp is operable on the basis of the lamp identification information.

6. A lamp unit, comprising:
a lamp holder for holding a lamp;
a lamp circuit part being disposed on the lamp holder; and
a connector for connecting the lamp circuit part electrically to a circuit part on a main unit side, wherein
the lamp circuit part has a storage part storing lamp management information for managing the lamp in a writable and readable manner.

7. The lamp unit according to claim 6, wherein
the lamp management information contains cumulative time information on cumulative operating time of the lamp.

8. The lamp unit according to claim 6, wherein
the lamp management information contains operability information on operability of the lamp.

9. The lamp unit according to claim 6, wherein
the lamp management information contains lamp identification information for identifying the lamp.
